(19) United States
(12) Patent Application Publication
(10) Pub. No.: US 2004/0036619 A1
(43) Pub. Date: Feb. 26, 2004

(54) Analog/discrete electrical interface panel with power monitoring and overcurrent protection

(75) Inventors: John Ray Berst, Plainfield, IL (US); Artur Didyk, Chicago, IL (US)

Correspondence Address: Thomas E. Hill, EMRICH & DITHMAR, Suite 3000, 300 S. Wacker Drive, Chicago, IL, 60606, US

(73) Assignee: COMPONENTS EXPRESS, LLC, Lemont, IL

(21) Appl. No.: 10/226,554

(22) Filed: Aug. 23, 2002

(51) Int. Cl. G08B 21/00

(52) U.S. Cl. 340/635; 340/664

(57) ABSTRACT

An alarm monitoring and electrical interface panel provides DC power to plural devices in a system as well as power and analog and/or discrete alarms to a system alarm controller in monitoring power provided to the devices within the system. The analog alarms include a first LED which turns off when input power to the electrical interface panel is lost and a second LED which turns off when output power to the device being controlled is lost such as due to a failure of the electrical interface panel. Also included is an overcurrent protection feature which limits the current provided to a powered device as well as the current provided to the system alarm controller. In the discrete alarm approach, a DC current is applied to the alarm signal for powering a device being controlled in the system. If power is lost, a third LED is turned off providing a visual indication of power failure.

### FIELD OF THE INVENTION

This invention relates generally to an arrangement for monitoring DC power provided to plural devices in a computer controlled system and providing a visual indication of a power failure or interruption in the system.

### BACKGROUND OF THE INVENTION

Computer controlled systems of increasing complexity are being used in more diverse applications and in greater numbers. In this type of distributed system, a central computer is typically connected to various remote devices for monitoring their status and controlling their operation. In monitoring the status of the various devices, an alarm is typically provided to a system operator when there is a problem in the system. This alarm may be audio, optical, or in printout form and is intended to alert the operator as to the nature and location of the problem and to perhaps suggest a solution to the problem. These types of computer controlled systems with alarm monitoring are increasingly being used in office environments because of the trend toward reductions in the central office staff. The types of systems and devices typically monitored in this environment include fire detection and protection, environmental control, security and computer systems such as for data processing.

The alarm detection and reporting circuits in these types of systems are generally passive in that the remote sensor typically operates as a switch. In this situation, a typical optical alarm device such as a light emitting diode (LED) would not operate because it also acts as a switch and the LED could not change its state, i.e., ON or OFF, in the event of an alarm condition.

The present invention addresses the aforementioned limitations of the prior art by providing an analog/discrete alarm electrical interface panel with power monitoring and overcurrent protection which provides power to plural operating devices in a system as well as to an alarm controller and monitors the operation of the devices for providing an alert indication in the event of a power failure.

### OBJECTS AND SUMMARY OF THE INVENTION

Accordingly, it is an object of the present invention to monitor power provided to plural devices in a controlled system.

It is another object of the present invention to provide analog and/or discrete alarms in a system having plural controlled devices to indicate a loss of power to one of more of the devices.

It is another object of the present invention to provide a power monitoring arrangement which provides a visual alarm indication upon loss of power to a device in the system and to limit the current to the device as well as to the power monitor to a safe level in the event of a failure, such as a short circuit.

Yet another object of the present invention is to provide a power monitoring arrangement which provides a first visual indication to a power controller when input power is lost, a second visual indication to the power controller upon failure of the power monitoring device itself, and limits the current being provided to a device being powered as well as to the power controller to a safe level in the event of either or both types of failure.

The present invention contemplates a power monitoring and alarm apparatus for use in a system wherein plural devices are powered by a DC power supply and are monitored by an alarm controller. This invention comprises first connectors coupled to the DC power supply for receiving a DC input; second connectors coupled to the plural devices; a circuit for coupling the first and second connectors for providing the DC input to each of the plural devices; and third connectors coupled to the circuit for providing the DC input to the alarm controller. The power monitoring and alarm apparatus further includes a power indicator for providing a visual indication of the absence of the DC input and a current limiter for limiting DC current provided to the devices and to the alarm controller.

The present invention further contemplates a power monitoring and alarm apparatus for use in a system wherein plural devices are powered by a DC power supply and are monitored by an alarm controller. This invention comprises first connectors coupled to the DC power supply for receiving a DC input; second connectors coupled to the plural devices; a circuit for coupling said first and second connectors for providing a DC output to each of the plural devices; and third connectors coupled to the circuit for providing the DC input to the controller. The power monitoring and alarm apparatus further includes a first power indicator coupled to the first connectors for providing a visual indication of the absence of the DC input, a second power indicator coupled to the second connectors for indicating absence of the DC output to each of the plural devices, a first current limiter coupled between the first and second connectors for limiting DC current provided to the devices and to the alarm controller, and a second current limiter coupled between the first and third connectors for limiting DC current provided to the alarm controller.

### BRIEF DESCRIPTION OF THE DRAWINGS

The appended claims set forth those novel features which characterize the invention. However, the invention itself, as well as further objects and advantages thereof, will best be understood by reference to the following detailed description of a preferred embodiment taken in conjunction with the accompanying drawings, where like reference characters identify like elements throughout the various figures, in which:

FIG. 1 is a simplified block diagram of a system within which an alarm electrical interface panel in accordance with the present invention is intended for use;

FIG. 2 is an upper perspective front view of an alarm electrical interface panel in accordance with the principles of the present invention;

FIG. 3 is an upper rear perspective view of the alarm electrical interface panel shown in FIG. 2;

FIG. 4 is a plan view of the rear portion of the alarm electrical interface panel of the present invention;

FIG. 5 is an upper perspective view of a front portion of the alarm electrical interface panel of the present invention with a portion of its housing removed;

FIG. 6 is simplified schematic diagram of a discrete alarm detection and alert arrangement for use in the present invention; and

FIG. 7 is a simplified schematic diagram of an analog alarm detection and alert arrangement with power monitoring in accordance with another aspect of the present invention.

### DETAILED DESCRIPTION OF THE PREFERRED EMBODIMENTS

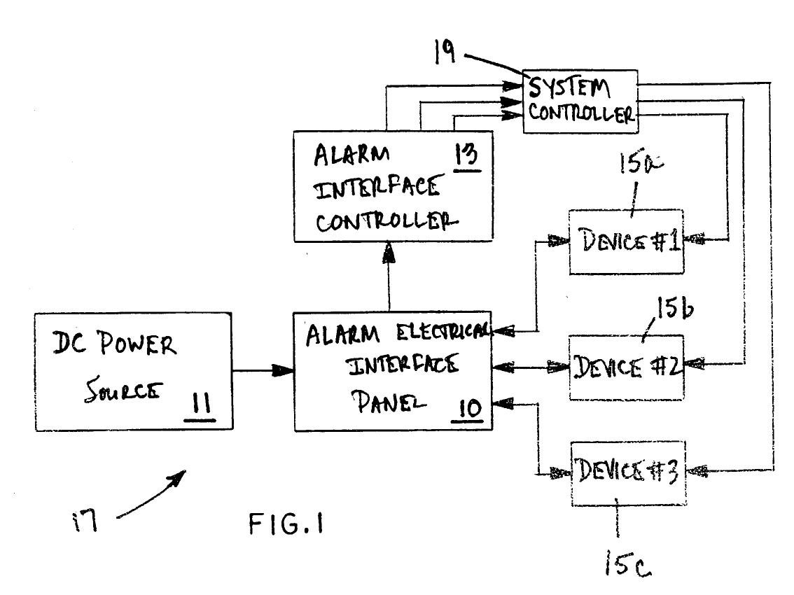

Referring to FIG. 1, there is shown a simplified block diagram of a computer controlled system 17 within which the alarm electrical interface panel 10 of the present invention is intended for use. System 17 includes a power source 11 providing a DC input to the alarm electrical interface panel 10. Power source 11 may take the form of any conventional DC source such as a storage battery. The alarm electrical interface panel 10 receives the DC input from the power source 11 and provides a DC output for powering plural devices such as device number one 15a, device number two 15b and device number three 15c. Devices one, two and three, 15a, 15b and 15c, may assume various forms such as a fire protection system, an air conditioning/heating system, a security system or a computer system. Inputs are provided to the alarm electrical interface panel 10 from each of the three devices 15a, 15b and 15c. The inputs from each of these devices to alarm electrical interface panel 10 relate in the case of the present invention to the providing of power to and the operation of each of the devices. The alarm electrical interface panel 10 detects the presence of the DC input from the power source 11 as well as the DC outputs to each of the three device 15a, 15b and 15c and provides appropriate inputs to the system's alarm interface controller 13. The alarm interface controller 13, in turn, provides appropriate inputs a system controller 19 which controls the operation of the entire system 17 including each of three devices 15a, 15b and 15c. FIG. 1 is intended to illustrate generally the type of system the present invention is intended for use as, for example, the system may include virtually any number of devices and may include more than one alarm interface controller and system controller.

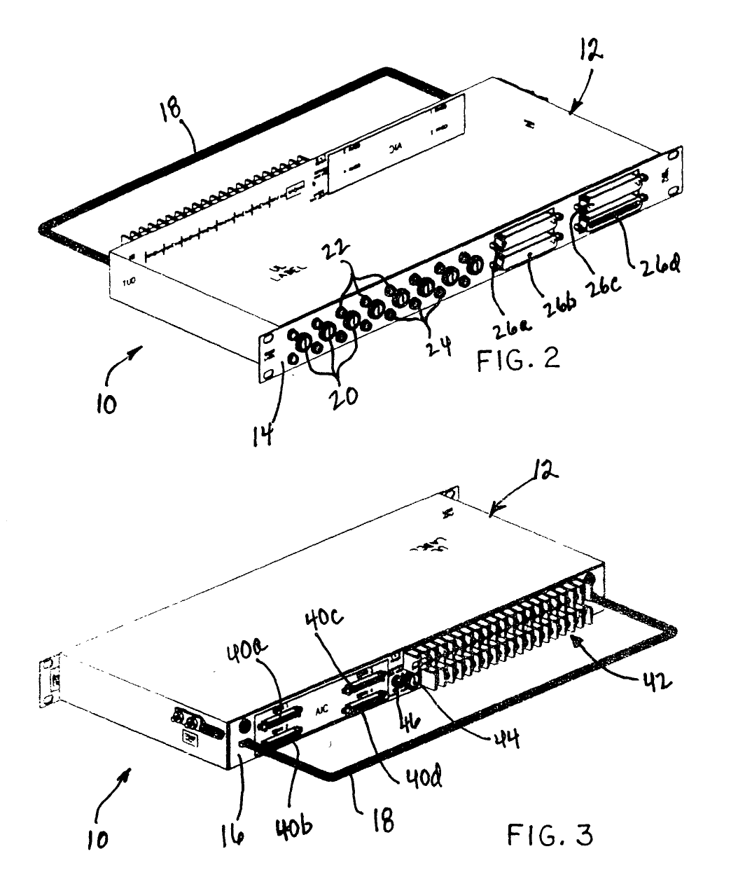

Referring to FIG. 2 there is shown a front upper perspective view of an alarm electrical interface panel 10 in accordance with the principals of the present invention. A rear upper perspective view of the inventive alarm electrical interface panel 10 is shown in FIG. 3.

The alarm electrical interface panel 10 includes a generally closed housing 12 having a front panel 14 and a back panel 16. Referring to FIG. 2 as well as to FIG. 5, which is a view of the alarm electrical interface panel 10 with portions of its housing removed, details of the front panel 14 will now be described. Front panel 14 includes first and second mounting flanges 28 and 30 disposed in respective ends thereof. The first mounting flange 28 includes first and second apertures 32a and 32b. Similarly, the second mounting flange 30 includes third and fourth apertures 34a and 34b. Each of the four apertures, 32a, 32b, 34a and 34b is adapted to receive a respective mounting pin, such as a screw or bolt, for mounting the alarm electrical interface panel 10 in an equipment rack (not shown for simplicity). Front panel 14 further includes eight (8) fuses 20, each of which is disposed in a respective analog alarm circuit with power monitoring as described in detail below. Front panel 14 further includes eight (8) input power indicators 22 each disposed above and adjacent to a respective one output power indicator 24. Each pair of input and output power indicators 22, 24 is disposed in the front panel 14 adjacent a respective fuse 20. Each fuse, which preferably has a rating of 20 amps(A), and its associated pair of input and output power indicators 22, 24 is disposed in a respective analog alarm circuit with power monitoring as described in detail below. Each of the input and output power indicators 22, 24 is preferably a light emitting diode (LED), with each input power indicator being green in color and each output power indicator also being green in color in a preferred embodiment. Also disposed in the front panel 14 are four small computer system interface (SCSI) I-type multi-port connectors which are sometimes referred to as “Teleco” connectors.

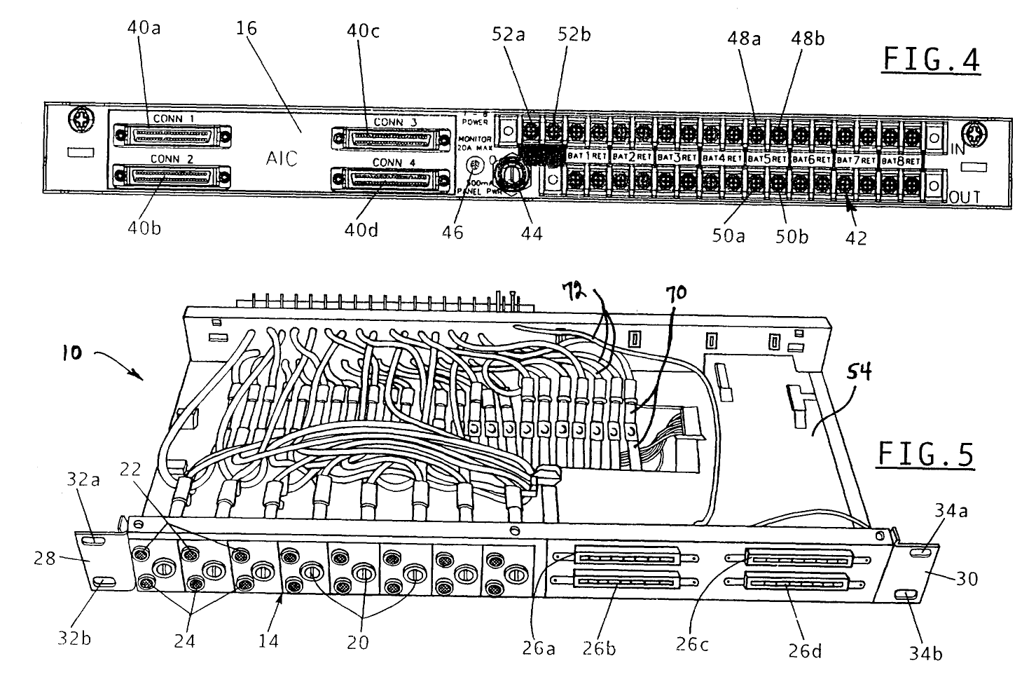

Referring to FIG. 3, details of the back panel 16 of the alarm electrical interface panel 10, which is also shown in the elevation view of FIG. 4 will now be described. Attached to the back panel 16 is a strain relief bar 18. Included in the back panel 16 are four SCSI II-type multi-port connectors 40a, 40b, 40c and 40d. Also disposed in the back panel 16 is a fuse 44 and a relay power indicator 46 which are in a discrete alarm circuit within the alarm electrical interface panel 10 as described in detail below. Also disposed in the back panel 16 is a terminal block 42 which includes eight (8) pairs of power input connectors 48a and 48b and eight associated pairs of power output connectors 50a and 50b. Power input connector 48a and 48b are connected to a DC power supply such as a battery with a return line. Similarly, each of the eight (8) pairs of power output connectors 50a and 50b is connected to a respective one of the operating devices in the system for providing DC power to the device. Each of the power input and power output connectors 48a, 48b and 50a, 50b is connected to the analog alarm circuit as described in detail below. Terminal block 42 further includes a pair of power input connector 52a and 52b connected to a 500 mA power supply (not shown) for powering relays within the alarm circuits in the alarm electrical interface panel 10.

Disposed within the alarm electrical interface panel 10 are one or more circuit boards 54, various connectors 70 and various conductors 72. Each combination of a connector 56 and a conductor 58 connects the various connectors, indicators and fuses on the front and back panels 14, 16 of the alarm electrical interface panel 10 to other circuit components disposed on the printed circuit boards 54 as described in the following paragraphs.

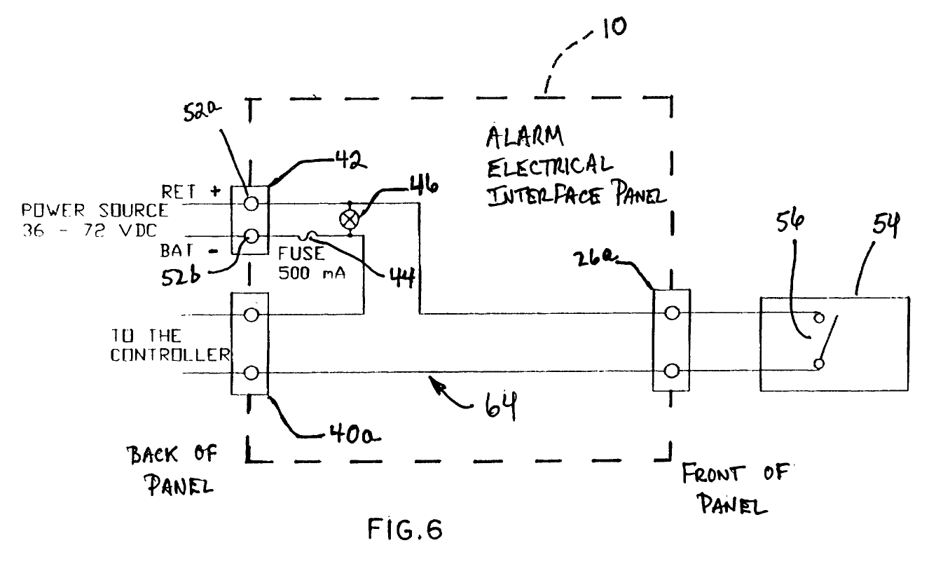

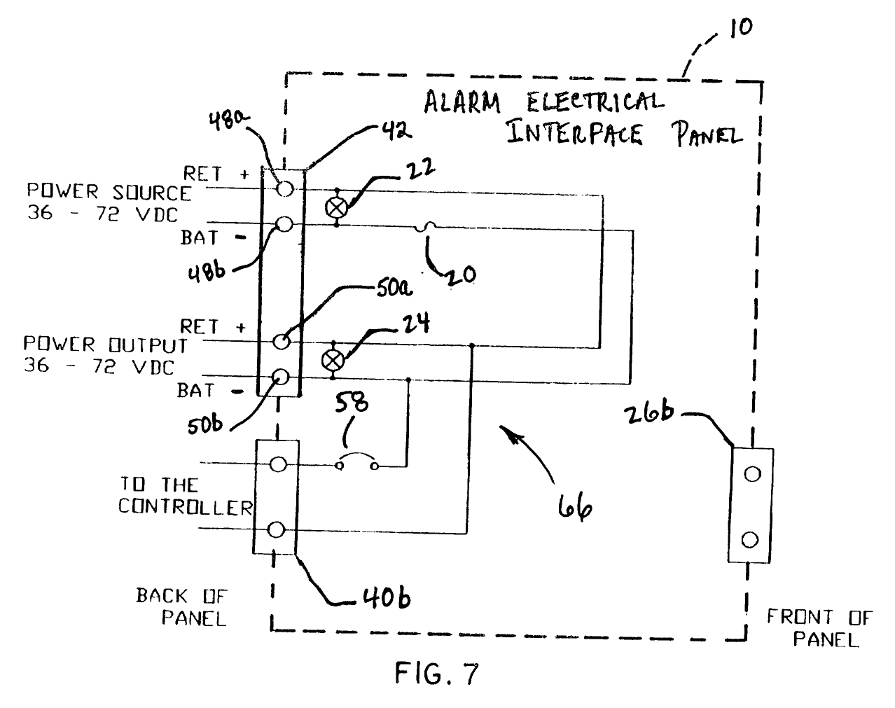

Referring to FIG. 6, there is shown a simplified schematic diagram of a discrete alarm circuit 64 in the alarm electrical interface panel 10, which is shown in the figure in dotted line form, in accordance with one aspect of the present invention. In FIG. 6, the back of the alarm electrical interface panel 10 is shown on the left and the front of the panel is shown on the right. As previously described, a DC power source is connected to the alarm electrical interface panel 10 by means of a terminal block 42. The DC power supply preferably provides 36-72 VDC to the alarm electrical interface panel 10. Coupled across the input DC conductors within the alarm electrical interface panel 10 is a power indicator 46. Also connected to one of the DC lines is a fuse 44, where both of these components are disposed in the back panel as previously described. Power indicator 46 is preferably an LED and fuse 44 preferably has a rating of 500 mA. The DC power supply is also connected via one of the SCSI I connectors on the front panel, such as SCSI I connector 26a, to the relay 56 in an alarm device 54. As previously described, alarm device 54 may be incorporated in a fire detection, air conditioning, security or computer system. The return line of the alarm device 54 is connected via the SCSI I connector 26a and a SCSI II connector, such as connector 40a on the back panel, to the alarm controller. The negative DC input to the alarm electrical interface panel 10 is also provided to the controller via the SCSI II connector 40a. Power is provided via the BAT/RET power input connectors 52a and 52b on terminal block 42. LED power indicator 46 illuminates indicating the application of input power across terminal block 42 unless fuse 44 is open. Fuse 44, which is preferably rated at 500 mA, provides overcurrent protection for the alarm electrical interface panel 10 as well as for the alarm interface controller 13. In the event of an alarm condition, the relay 56 in alarm device 54 closes resulting in power being provided through the alarm electrical interface panel 10 to the alarm interface controller 13.

Referring to FIG. 7, there is shown a simplified schematic diagram of an analog alarm circuit with power monitoring 66 in accordance with another aspect of the present invention. As in the previously described figure, the alarm electrical interface panel 10 is shown in dotted line form with the back of the panel shown on the left hand portion of the figure and the front of the panel shown on the right hand portion of the figure. A DC power source, which preferably provides a DC voltage in the range of 36-72 VDC, is connected to the alarm electrical interface panel 10 by means of terminal block 42 as previously described. The power source input is provided via power input battery and return connectors 48a and 48b in the terminal block 42. DC power output is provided from the terminal block 42 via power output battery and return connectors 50a and 50b to a device within the system which is being powered and monitored by the alarm electrical interface panel. A first input power indicator 22 is coupled across the input lines within the alarm electrical interface panel 10 for providing visual indication of the receipt of DC power from the power source. Illumination of the first input power indicator 22 indicates a DC input to the alarm electrical interface panel 10. A second output power indicator 24 is coupled across the DC output line of the alarm electrical interface panel 10 connected to the device being powered via the alarm electrical interface panel. Illumination of the second output power indicator 24 indicates that output power is being provided to the device being powered by the DC output of the alarm electrical interface panel 10. Also disposed in the circuit is a fuse 20 (preferably having a rating of 20 A), for limiting the DC current provided to the device being powered via the alarm electrical interface panel 10. The DC output from the alarm electrical interface panel 10 is also provided to the system controller via one of the SCSI II connector, such as the second SCSI II connector 40b, as shown in FIG. 7. This DC output from the alarm electrical interface panel 10 provides the alarm interface controller 13 with information on a realtime basis as to whether the device being controlled is receiving input power. With this information, the controller can make decisions regarding the overall operation of the system based upon whether the alarm devices being monitored and controlled are operating properly. Included in the DC circuit providing output power to the controller is a thermistor 58 preferably having a rating of 25 mA. When the DC current to the alarm controller exceeds 25 mA, the thermistor 58 opens protecting the alarm controller from large DC currents. When the current returns to a value less than 25 mA, thermistor 58 automatically resets and DC input current to the alarm controller is resumed.

While particular embodiments of the present invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention. The matters set forth in the foregoing description and accompanying drawings are offered by way of illustration only and not as a limitation. The actual scope of the invention is intended to be defined in the following claims when viewed in their proper perspective based on the prior art.

I claim:

1. For use in a system wherein plural devices are powered by a DC power supply and are monitored by an alarm controller, a power monitoring and alarm apparatus comprising:
first connectors coupled to the DC power supply for receiving a DC input;
second connectors coupled to the plural devices;
circuit means for coupling said first and second connectors for providing the DC input to each of said plural devices; and
third connectors coupled to said circuit means for providing the DC input to the alarm controller;
wherein said circuit means includes a power indicator for providing a visual indication of the absence of the DC input and a current limiter for limiting DC current provided to the devices and to the alarm controller.

2. The power monitoring and alarm apparatus of claim 1 wherein said power indicator is a light emitting diode.

3. The power monitoring and alarm apparatus of claim 1 wherein said current limiter is a fuse.

4. The power monitoring and alarm apparatus of claim 3 wherein said fuse limits the current to 500 mA.

5. The power monitoring and alarm apparatus of claim 1 wherein the alarm controller is powered by the DC input from said power monitoring and alarm apparatus.

6. The power monitoring and alarm apparatus of claim 1 wherein said first connectors are disposed in a terminal block, said second connectors are small computer system interface (SCSI) I multi-port connectors, and said third connectors are SCSI II connectors.

7. The power monitoring and alarm apparatus of claim 1 wherein each of the plural devices includes a relay and wherein the DC input to a respective device permits a determination of whether its associated relay is open or closed.

8. For use in a system wherein plural devices are powered by a DC power supply and are monitored by an alarm controller, a power monitoring and alarm apparatus comprising:
first connectors coupled to the DC power supply for receiving a DC input;
second connectors coupled to the plural devices;
circuit means for coupling said first and second connectors for providing a DC output to each of said plural devices; and
third connectors coupled to said circuit means for providing the DC input in the controller;
wherein said circuit means includes a first power indicator coupled to said first connectors for providing a visual indication of the absence of said DC input, a second power indicator coupled to said second connectors for indicating absence of said DC output to each of the plural devices, a first current limiter coupled between said first and second connectors for limiting DC current provided to the devices, and a second current limiter coupled between said first and third connectors for limiting DC current provided to the alarm controller.

9. The power monitoring and alarm apparatus of claim 8 wherein set first and second power indicators are light emitting diodes (LEDs).

10. The power monitoring and alarm apparatus of claim 9 wherein said first and second power indicators are green LEDs.

11. The power monitoring and alarm apparatus of claim 8 wherein said first current limiter is a fuse.

12. The power monitoring and alarm apparatus of claim 11 wherein said fuse has a 20 A rating.

13. The power monitoring and alarm apparatus of claim 11 wherein said second current limiter breaks contacts and interrupts the DC output to the alarm controller when the DC current exceeds a predetermined limit and resets to again provide the DC output to the alarm controller when the DC current returns to a value less than said predetermined limit.

14. The power monitoring and alarm apparatus of claim 13 wherein said second current limiter is a thermistor.

15. The power monitoring and alarm apparatus of claim 8 wherein said first and second connectors are disposed in a terminal block and said third connector are small computer system interface (SCSI) II multi-port connectors.
